(19) United States
(12) Patent Application Publication
(10) Pub. No.: US 2020/0172993 A1
(43) Pub. Date: Jun. 4, 2020

(54) METHOD AND A SYSTEM FOR GOLD RECOVERY FROM HALOGEN EXTRACTION TREATMENT

(71) Applicant: DUNDEE SUSTAINABLE TECHNOLOGIES INC., Montreal (CA)

(72) Inventors: BERTRAND DUBREUIL, SHERBROOKE (CA); JEAN-MARC LALANCETTE, SHERBROOKE (CA); DAVID LEMIEUX, THETFORD MINES (CA)

(21) Appl. No.: 16/208,745

(22) Filed: Dec. 4, 2018

(51) Int. Cl. C22B 3/00; C22B 11/06

(52) U.S. Cl. CPC C22B 11/04; B01J 20/103; C22B 11/06

(57) ABSTRACT

A method and a system for gold and silver recovery from a pregnant solution resulting from gold extraction from an ore using halogen, the method comprising lowering the oxidation reduction potential of the pregnant solution by mixing the pregnant solution with a reducer over the surface of a bed of silica, and flowing the mixture through the bed of silica. The system comprises a bed of silica, a feeder controlling feeding of the pregnant solution with a reducer to direct a mixture of an ORP less than 550 mV to the surface of the bed of silica, and a collector receiving a barren solution from the bed of silica after flowing of the mixture therethrough.

### FIELD OF THE INVENTION

The present invention relates to gold recovery. More specifically, the present invention is concerned with a method and a system for gold recovery from a pregnant solution resulting from halogen extraction of gold from an ore.

### BACKGROUND OF THE INVENTION

Extraction of gold and silver with halogens, chlorine in the presence of bromine was described in U.S. Pat. Nos. 7,537,74162; 9,051,62662; 9,206,49262 for example. According to one such method, the extracted precious metals are dissolved as complexed chlorides in a brine solution of NaCl and NaBr of an oxidation reduction potential (ORP) in the range between about 1 100 and about 900 mV. Activated carbon may not be used for recovery of the precious metals from this solution because halogens, in particularly bromine, react irreversibly with the carbon, thus preventing the recycling of the reagents and leaving a brominated carbon of problematic nature.

Another method for precious metals recovery is based on the precipitation of the precious metals over particulates. In U.S. Pat. No. 9,206,491 for example, particles of silica having a BET specific surface area in the range of one square meter per gram were used as collectors. Using sodium sulfite as a reducer, it was possible to recover essentially all the gold and silver from the pregnant solution. The duration of the operation could vary from one to ten hours and the consumption of the reducing agent was variable, depending on the duration of the process. The silica, when used as a slurry, lead to gold-loaded material losses during filtrations.

There is still a need in the art for a method and a system for gold recovery from a pregnant solution resulting from halogen extraction.

The present description refers to a number of documents, the content of which is herein incorporated by reference in their entirety.

### SUMMARY OF THE INVENTION

More specifically, in accordance with the present invention, there is provided a method for gold and silver recovery from a pregnant solution resulting from gold extraction from an ore using halogen, comprising lowering the oxidation reduction potential of the pregnant solution by mixing the pregnant solution with a reducer over the surface of a bed of silica, and flowing the mixture through the bed of silica.

There is further provided a system for gold and silver recovery from a pregnant solution resulting from leaching of gold from an ore with halogen, comprising a bed of silica, a feeder controlling feeding of the pregnant solution with a reducer to direct a mixture of an ORP less than 550 mV to the surface of the bed of silica, and a collector receiving a barren solution from the bed of silica after flowing of the mixture therethrough.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a schematic view of a system according to an embodiment of an aspect of the present disclosure.

### DESCRIPTION OF ILLUSTRATIVE EMBODIMENTS

The present invention is illustrated in further details by the following non-limiting examples.

In methods for precious metals recovery based on the precipitation of the precious metals of a pregnant solution (S1) resulting from the leaching of gold and silver ores with hypohalites, and having an ORP comprised in the range between about 1100 mV and about 900 mV, the reduction of the ORP of the pregnant solution below 550 mV liberates the precious metals in the form of gold generally accompanied by traces of silver, as metallic species.

Using silica particles having a BET specific surface area of the order of 1 square meter per gram allows to collect these metallic species on a slurry of these silica particles without significant loss on the walls of the reactor. However, the duration of the operation may be highly variable, from one to ten hours when using either ferrous sulfate or sodium sulfite as the reducing agent; moreover, handling losses occur during the method.

Surprisingly, it was found that using a collector under the form of a silica gel mounted in a static bed in a column, instead of as silica slurried in the pregnant solution as known in the art, and feeding the reducing agent on top of the column of silica gel with good mixing with the pregnant solution, allowed a small amount of silica to collect a very large amount of gold, raising the gold content of the silica collector to values as high as 17% while releasing a barren solution with less than 0.02 ppm of gold. Pregnant solution with as low as 2 ppm of gold can thus be processed, with contact time of less than 10 minutes using a bed of silica gel. In order to ensure an appropriate permeability of the bed of silica gel, it may be mixed with a solid diluent, which may be a fine crystalline silica of a specific surface area of about 1 m²/g for example.

When the loading of the silica gel with gold is completed as evidenced by a black color at the surface of the bed, the silica gel is retrieved and melted with a flux to release gold/silver value.

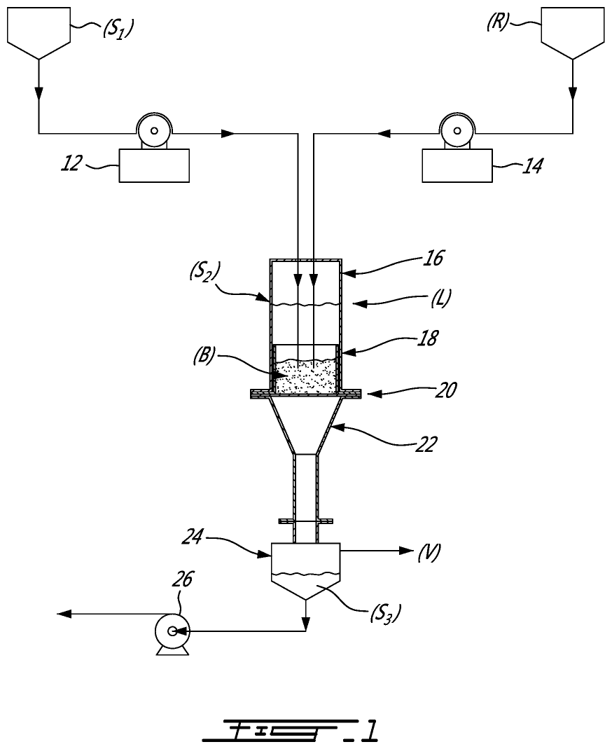

A system according to an embodiment of an aspect the present disclosure is illustrated in FIG. 1. A pregnant solution (S1) resulting from the leaching of gold silver ores with hypohalites and having an ORP comprised in the range between about 1100 mV and about 900 mV, and a reducer (R) are fed to the surface of a static bed of silica gel (B). The feeding rates of the pregnant solution (S1) and the reducer (R) are controlled using metering pumps 12 and 14 respectively, to yield a solution (S2) of an ORP less than about 550 mV to the surface of a static bed of silica gel (B).

As illustrated in FIG. 1, the bed of silica gel (B) is positioned in a tube 16 receiving the mixture of the pregnant solution (S1) and the reducer (R), in a sleeve 18 sitting on a filtering medium 20 within the tube 16. A perforated collector 22 below the filtering medium 20 leads to a collector 24.

The flow rate of the solution (S2) from over the bed of silica gel (B) to the receiver 24 through the perforated collector 22 is controlled by application of a controlled vacuum (see arrow (V)) on the receiver 24 so as to keep the level (L) of the solution (S2) within the tube 16 on top of the bed of silica gel (B) near a stable value. A barren solution (S3) collected in the receiver 24 may be pumped out (see pump 26) to be recycled by oxidation to further gold extraction, as described in U.S. Pat. No. 9,206,491 B2 for instance.

Thus, gold is deposited on the bed of silica gel (B), as the solution (S2) flows through the bed of silica gel with a very short contact time. Once the bed of silica gel (B) is saturated, it may be retrieved by removing the filtering medium 20 supporting the sleeve 18, forming disposable and fusible container, and containing the saturated the bed of silica gel (B) from the system.

Experiments were performed, in which the BET specific surface area of the silica was increased from 1 m²/g to 450 m² by substituting silica gel to crystalline silica. Using ferrous sulfate as a reducer, is was noted that the time required to achieve a completed precipitation of gold was about twice as long on crystalline silica as on silica gel.

Sodium metabisufite as a reducer allowed a complete precipitation over silica gel (of a BET specific surface area of 450 m²/g) after 30 minutes, while ferrous sulfate required 100 minutes to achieve the same result. Sodium sulfite was slightly slower than metabisulfite at 50 minutes. The contact time was adjusted depending on the amount of silica and of the volume of pregnant solution to be treated, to collect the gold value.

Experiments were performed, in which the silica, either as crystalline silica (BET specific surface area of 1 m²/g) or silica gel (BET specific surface area of 450 m²/g), was contacted with a pregnant solution having an ORP of 1 121 mV, using a ratio of one gram of silica per 1 300 g of the pregnant solution. The reducer was added so as to reduce the ORP below 500 mV. The residual gold in solution was determined by ICP-AES analysis. The silica gel used was Alfa Aesar™60.

The results in Table 1 below indicate the time required for the complete adsorption of gold on the silica:

TABLE 1

| | Solution Au | SiO₂ | | |
|---|---|---|---|---|
| | ORP 1 121 mV | BET specific | Reducer | Duration |
| Experiments | concentration | surface area | Below 500 mV | (minutes) |
| 1 | 2.5 ppm | 1 m²/g | FeSO₄•7 H₂O | 200 |
| 2 | 2.5 ppm | 450 m²/g | FeSO₄•7 H₂O | 100 |
| 3 | 2.7 ppm | 450 m²/g | Na₂SO₃ | 50 |
| 4 | 2.7 ppm | 450 m²/g | Na₂SO₃ | 30 |

In another experiment, a solution of 500 ml having a gold concentration of 1 266 mg/l Au and an ORP of 980 mV was circulated with 500 ml of a solution of sodium sulfite (12. g/l) at a constant rate for two hours, over a bed made with 5.0 g of silica gel (450 m²/g) and 5.0 of crystalline silica (1 m²/g). The mixing of the two liquids was done at the surface of the bed as discussed hereinabove in relation to FIG. 1. The duration of the contact of the solution with the silica column was one minute. It was noted that the precipitated gold formed a black layer on the top surface of the silica bed. The barren solution at the bottom of the column was analysed and contained 0.78 mg/L indicating an essentially complete recovery of gold (99.9%).

In still another experiment, a one-liter sample of a gold solution 1 266 mg/l Au at an ORP of 980 mV was divided into ten 100 ml fractions. Each fraction was contacted successively with 4.0 of silica gel 450 m²/g as a bed in a column, with a contact time of one hour, the barren solution being decanted after each contact. After these ten exposures to the gold solution, the silica was submitted to a fire assay which indicated a gold content of 170 700 g/t Au in the silica, this value corresponding to a recovery of 99.94% of the gold in the starting solutions and a concentration of 17% (w/w) of gold on the silica.

A method according to an aspect of the present disclosure for recovery of gold and silver from a pregnant solution resulting from extraction of gold and silver using halogens (Cl₂, Br₂), comprises precipitating precious metals from the pregnant solution by reduction of the ORP of the pregnant solution from values in the range of 1100-900 mV to less than 550 mV, at the surface of a static bed of a silica having a BET specific surface area of at least 350 m²/gm, using sodium metabisulfite (Na₂S₂O₅) as reducing agent.

Deposition of the of precious metals is completed in minutes and the barren solution may be recycled to further gold extraction. Gold accumulate on the static silica bed to a content of more than 15% w/w even with pregnant solutions containing as little as two ppm of gold.

The pregnant solution may be concentrated, with up to about 1 000 ppm Au, or diluted, with as low as about 2 ppm Au.

Since in the present method and system the silica collector is static, as opposed to a circulating slurry for instance, the saturated bed being transferred with its container to fusion as described hereinabove, gold losses due to filtration or other handling operations are avoided.

The method allows successive deposition of gold on a given bed of silica gel with a very short contact time using concentrated (1 000 ppm Au) or diluted (2 ppm Au) pregnant solution and avoid handling gold losses. It was demonstrated that gold deposit best on gold. Therefore, having a layer of gold particles on top of the silica bed is allows an efficient and complete deposition.

A method for gold and silver recovery from a pregnant solution resulting from a chloride extraction of gold according to an aspect of the present disclosure comprises reducing the ORP of the pregnant solution from a range comprised between about 1 100 and about 900 mV to less than about 550 mV by mixing the pregnant solution with a solution of reducer over the surface of a bed of silica through which the mixture of solution is made to circulate.

The silica gel is selected with a BET specific surface area above about 350 m²/g, for example above about 400 m²/g, for example above about 450 m²/g. The high BET specific surface area silica, for example silica with a BET specific surface area above about 450 m²/g, may be mixed with a solid diluent, such as fine crystalline silica of a BET specific surface area of about 1 m²/g for example, in order to allow an improved permeability, and allowing adjustment of the contact time of the mixture of solution with silica in a range between about 1 minute and about ten minutes.

The reducer is one of ferrous sulfate, sodium sulfite and sodium metabisulfite.

Precipitation of gold on the silica bed may be performed in a disposable and fusible container, made of fiberglass, borosilicate glass or recycled glass for example, preventing losses of gold-loaded silica.

The scope of the claims should not be limited by the embodiments set forth in the examples, but should be given the broadest interpretation consistent with the description as a whole.

1. A method for gold and silver recovery from a pregnant solution resulting from gold extraction from an ore using halogen, comprising lowering the oxidation reduction potential of the pregnant solution by mixing the pregnant solution with a reducer over the surface of a bed of silica, and flowing the mixture through the bed of silica.

2. The method as in claim 1, comprising lowering the oxidation reduction potential of the pregnant solution from a range comprised between 1100 mV and 900 mV to below 550 mV.

3. The method as in claim 1, where the bed of silica comprises a silica gel having a specific surface area of at least 350 m²/g.

4. The method as in claim 1, wherein the bed of silica comprises a silica gel having a specific surface area of at least 400 m²/g.

5. The method as in claim 1, wherein the bed of silica comprises a silica gel having a specific surface area of at least 450 m²/g.

6. The method of claim 1, wherein the bed of silica comprises a silica gel having a specific surface area of at least 350 m²/g mixed with a solid diluent.

7. The method of claim 1, wherein the bed of silica comprises a silica gel having a specific surface area of at least 350 m²/g mixed with crystalline silica.

8. The method of claim 1, wherein the bed of silica comprises a silica gel having a specific surface area of at least 350 m²/g mixed with crystalline silica having a specific surface area of about 1 m²/g.

9. The method of claim 1, wherein the reducer is one of: ferrous sulfate, sodium sulfite and sodium metabisulfite.

10. The method of claim 1, wherein the reducer is sodium metabisulfite.

11. The method of claim 1, comprising precipitation of gold on the silica bed within a disposable and fusible container.

12. The method of claim 1, comprising mounting the bed of silica in a column and feeding the mixture of the pregnant solution and the reducer on top of the column of silica gel.

13. The method of claim 1, comprising retrieving a barren solution and recycling the barren solution to further gold extraction.

14. A system for gold and silver recovery from a pregnant solution resulting from leaching of gold from an ore with halogen, comprising a bed of silica, a feeder controlling feeding of the pregnant solution with a reducer to direct a mixture of an ORP less than 550 mV to the surface of said bed of silica, and a collector receiving a barren solution from said bed of silica after flowing of the mixture therethrough.

15. The system of claim 14, wherein said bed of silica is positioned in a container, said container being made in one of fiberglass, borosilicate glass and recycled glass, and being removable from the system.

16. The system of claim 14, wherein said bed of silica in housed in a container, said container being removable from the system.

17. The system of claim 14, wherein said bed of silica comprises a silica gel having a specific surface area of at least 350 m²/g.

18. The system of claim 14, wherein said bed of silica comprises a silica gel having a specific surface area of at least 350 m²/g mixed with a solid diluent.

19. The system of claim 14, wherein said bed of silica comprises a silica gel having a specific surface area of at least 350 m²/g mixed with crystalline silica.

20. The system of claim 14, wherein said bed of silica comprises a silica gel having a specific surface area of at least 350 m²/g mixed with crystalline silica having a specific surface area of about 1 m²/g.
